(19) United States
(12) Patent Application Publication
(10) Pub. No.: US 2001/0038326 A1
(43) Pub. Date: Nov. 8, 2001

(54) Spring contact unit for a relay with a rocker armature

(76) Inventor: Michael Dittmann, Berlin (DE)

Correspondence Address: Tyco Technology Resources, Suite 450, 4550 New Linden Hill Road, Wilmington, DE, 19808, US

(21) Appl. No.: 09/815,976

(22) Filed: Mar. 23, 2001

(30) Foreign Application Priority Data
Mar. 31, 2000 (EP) 00106903.8

(51) Int. Cl. H01H 51/22

(52) U.S. Cl. 335/80

(57) ABSTRACT

A spring contact unit has spring contacts designed as bridge contacts and a spring element located therebetween that are connected to the spring element in an insulated manner and the faces of the spring contacts are small, while the spring element is relatively large, as it contains resilient portions for applying the contact force so the large-surface spring element can be earthed to allow a spring contact unit suitable for high frequency.

### BACKGROUND OF THE INVENTION

The invention relates to a spring contact unit for a relay with a rocker armature which is particularly suitable for high frequency applications.

### DESCRIPTION OF THE PRIOR ART

Relays with a rocker armature are known in great numbers. Relays of this type usually have a symmetrical magnetic system, an armature bridging the stretch between two pole faces of a core arrangement. The armature is pivotally mounted in the center between the pole faces and connected to a spring contact unit. Switching contacts located on spring contacts are switched between a closed and an open position due to the movement of the armature.

A relay is known, for example, from DE 43 09 618 A1 which has a rocker armature with a spring contact unit fastened thereon. The spring contact unit consists here of two elongated spring contacts which are embedded in a central portion in a molded-plastic component. Mounting strips, on which the spring contact unit is applied on a stationary relay part, are molded onto the spring contacts on the longitudinal sides in the central region. The spring contacts are insulated from one another so that the mounting strips represent simultaneously the electrical connection to one of the spring contacts, in each case. A design of this type of the spring contact unit is, however, inadequate for high frequency applications, as a relatively strong electromagnetic coupling between the two spring contacts, which are otherwise insulated from one another, is inevitable.

### SUMMARY OF THE INVENTION

It is therefore the object of the invention to disclose a spring contact unit for a relay with a rocker armature which is also suitable for high frequency relays. Nevertheless, a spring contact unit of this type should also be simply designed and produced.

This object is achieved according to the invention by a spring contact unit with a rocker armature with at least two spring contacts designed as bridging contacts, a spring element arranged between the spring contacts, two fastening elements arranged in the center on two opposing sides of the spring element, the spring contacts, in each case, being fastened in an insulated manner on an outer end of the spring element, and resilient portions being located between the fastening points of the spring contacts on the spring element and a central region of the spring element.

The main advantage of the spring contact unit according to the invention lies in the fact that the spring contacts can be designed in such a way that they only have a very small face and are therefore insensitive to couplings. Moreover, they can be produced from a material with high electrical conductivity but relatively poor spring properties, which is a further advantage. This possibility results from the fact that the spring contacts are subjected only to a slight spring-loading while the main spring-loading is on the spring element. The spring element which has a relatively large face and is sensitive to electromagnetic and electrical couplings can be earthed, so that no problems can arise therefrom. In an advantageous embodiment, the spring contacts are designed as slotted leaf springs, so double contacts are formed. One leg of the protected region can be extended in design here, so that these regions can cooperate with earthing tabs in the opened state, so the spring contacts are earthed in the opened state. The other legs of the slotted regions, in each case, are then short in design to keep the overall size small.

When using a spring contact unit according to the invention in a relay, an armature of the relay is preferably connected to the spring contact unit by a molded-plastic component. The fastening elements of the spring contact unit thus form an armature swivel axis.

Further details and embodiments of the invention are given in the sub-claims.

### BRIEF DESCRIPTION OF THE DRAWINGS

FIG. 1 shows a relay with a spring contact unit according to the invention;

FIG. 2 shows a first embodiment of a spring contact unit according to the invention;

FIG. 3 shows the spring contact unit in FIG. 2 with an armature assembled thereon;

FIG. 4 shows a stationary contact unit for the spring contact unit in FIGS. 2 and 3;

FIG. 5 shows a second embodiment of a spring contact unit according to the invention;

FIG. 6 shows the spring contact unit from FIG. 5 with a molded-plastic component formed by encapsulation by injection moulding;

FIG. 7 shows the stationary contact unit for the spring contact unit in FIGS. 5 and 6; and

FIG. 8 shows a header unit for a spring contact unit according to the invention.

### DETAILED DESCRIPTION OF THE PREFERRED EMBODIMENT

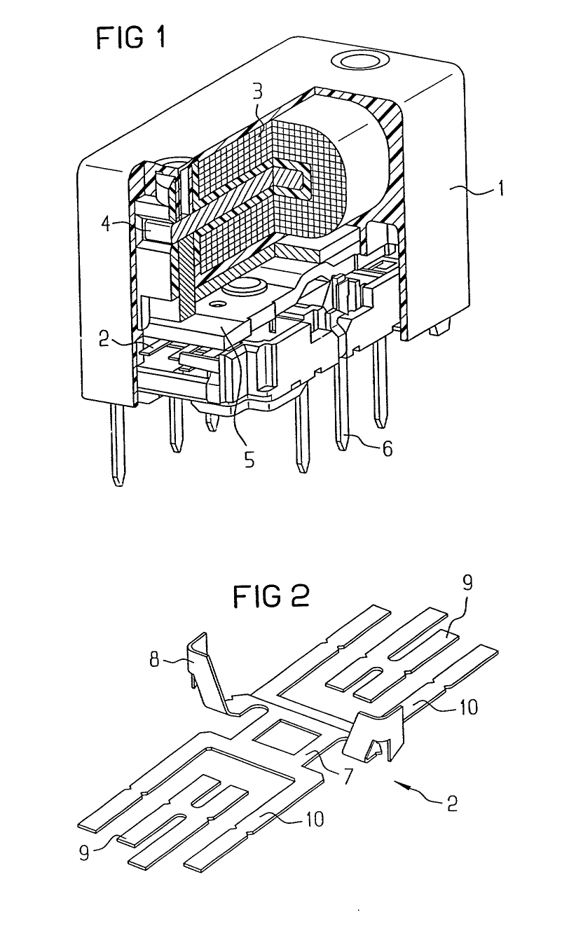

FIG. 1 shows a relay provided for receiving a spring contact unit 2 according to the invention. A coil 3 with a core arrangement 4 is provided in the upper part of a housing 1. Underneath it is an armature 5 located on the spring contact unit 2. Connecting elements 6 extend from the lower part of the housing 1. FIG. 2 shows the spring contact unit 2, which is used in the relay in FIG. 1, separately. The spring contact unit has a spring element 7, in the center of which fastening elements 8 are provided on two opposing sides. Spring contacts 9 are provided, in each case, in the direction of the two outer ends of the spring element.

FIG. 2 does not show the spring contacts connected to the spring element 7, as only the metal parts of the spring contact unit 2 are shown and the connection between the spring element 7 and the spring contacts 9 is made by molded-plastic components. The essential point of the invention consists in the fact that the spring contacts 9 are fastened to the spring element 7 in the direction of the outer ends thereof through resilient portions 10 that are located between the fastening points of the spring contacts 9 on the spring element 7 and the central region of the spring element 7. The main contact force is therefore not applied by the spring contacts 9, but by the resilient portions 10 of the spring element 7. There is therefore the possibility of keeping the spring contacts 9 relatively small, so that they are insensitive to electrical or electromagnetic couplings.

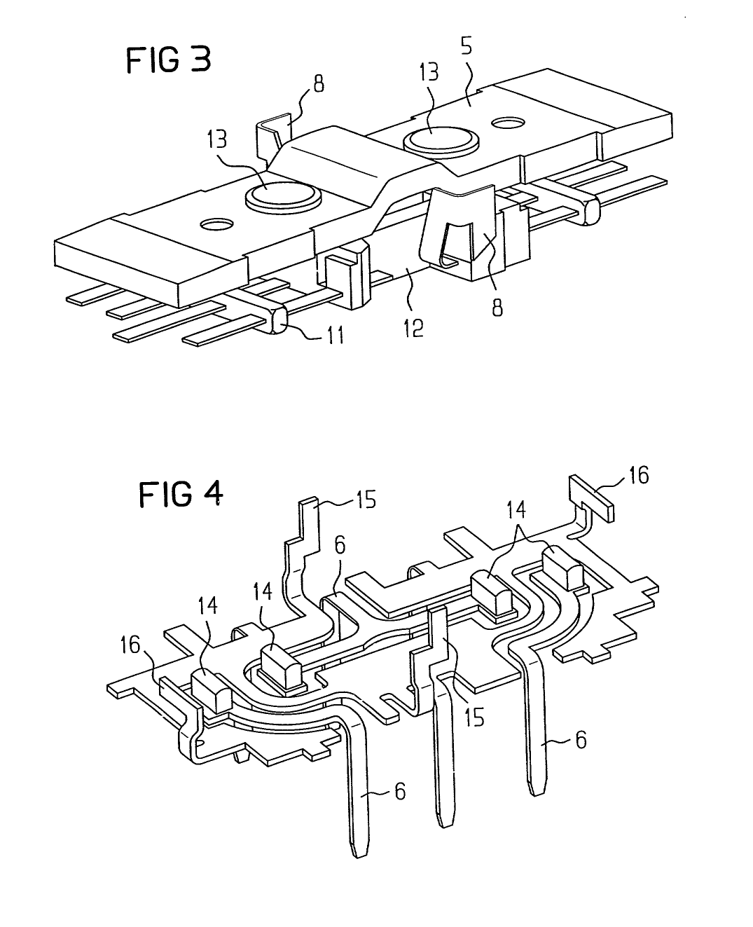

Connecting elements connecting the spring contacts 9 to the spring element 7 are not shown in FIG. 2, as already mentioned. However, they can be seen in FIG. 3. The connecting elements 11 shown there extend over the whole breadth of the spring contact unit 2, in a web-like manner. These connecting elements 11 are advantageously produced in an injection moulding process. Also produced in an injection moulding process is a molded-plastic component 12 which surrounds the central region of the spring element 7 and is located on the armature 5. Journals 13 of the molded-plastic component 12 extend, in this process, through corresponding recesses in the armature 5, projecting through the recesses and fixing the armature 5 in this position on the upper side of the armature 5 by thermal deformation. The fastening elements 8 are advantageously designed in such a way that they form a face which is perpendicular to the plane in which the spring contact unit 2 is located or which is determined by the base of a socket unit of a relay. The advantage of this design will be explained hereinafter.

FIG. 4 shows a suitable stationary contact unit. The spring contacts 9 need, in each case, two stationary contacts 14. Connecting elements 6 extend on from the stationary contacts 14 and are bent downwards in such a way that the connecting elements 6 project from the plastic material of the encapsulation after the partial encapsulation has been formed by injection moulding of the metal elements shown. A header is thus formed. The stationary contact unit also fulfils a further function. The assembly arms 15 are bent upwards in such a way that they extend parallel to the fastening elements 8 of the spring contact unit. When the spring unit is used on the stationary contact unit, the spacing between the spring contacts 9 and the stationary contacts 14 can thereby be adjusted, the fastening elements 8 being welded in the adjusted position to the assembly arms 15 adjacent thereto. Connecting elements are also bent off from the assembly arms 15, so that the assembly arms 15 can be connected to earth potential. The spring element 7 of the spring contact unit 2 is thus also connected to earth potential in the installed state. As a result, the two spring contacts 9 are decoupled from one another, and the damping is increased sharply. As the resilient portions 10 of the spring element 7 on which the spring contacts 9 are fastened, extend laterally over the whole length of the spring contacts 9, there is also screening towards the sides. The elements of the stationary contact unit provided for connecting to earth potential are of as large a surface as possible for screening purposes.

As a further feature of the stationary contact unit, earthing tabs 16 are provided, as a result of which the possibility for movement of the spring contacts 9 is limited in the installed state of the spring contact unit 2. The possibility for movement is limited by the stationary contacts 14 in one direction and by these same earthing tabs 16 in the other direction. As the earthing tabs 16 are also connected to earth potential and the spring contacts 9 contact the earthing tabs 16 in the opened state, the spring contacts 9 are, in each case, earthed in the open state.

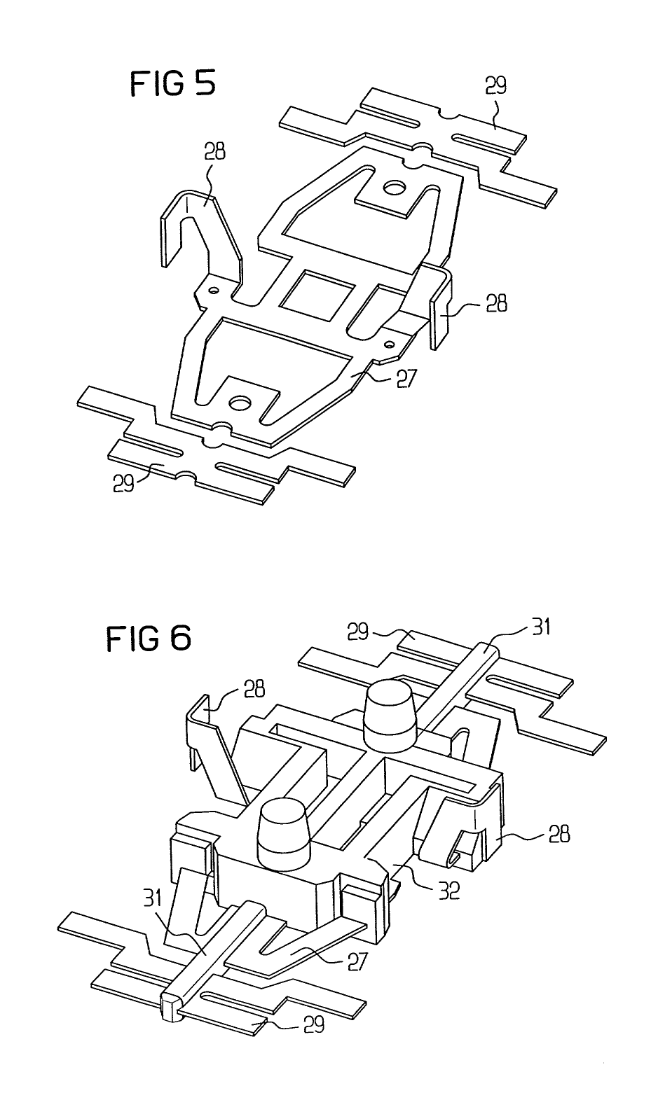

FIG. 5 shows a second embodiment of a spring contact unit, according to the invention. The central region of a spring element 27 and fastening elements 28 molded thereon do not substantially differ from the first embodiment of the previous figures. However, while the spring element 7 of the first embodiment is U-shaped in design so that two legs are produced, the spring element 27 is frame-shaped on the two sides of the central region. Spring contacts 29 extend perpendicular to the longitudinal axis of the spring element 27.

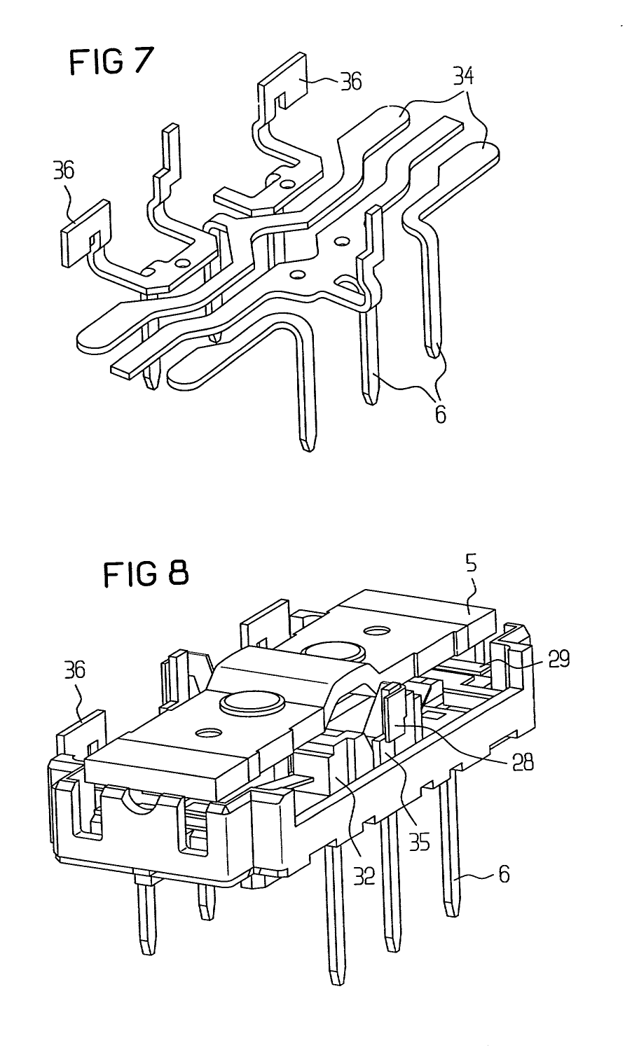

FIG. 6 shows how this embodiment of a spring contact unit according to the invention is embedded in the central region in a molded-plastic component 32, so that there is, in turn, the possibility of positioning an armature. The spring element 27 is connected to the spring contacts 29, in each case, via a plastics material connecting element 31. The spring contacts 29 are slotted in design. This results in two short arms and two long arms, in each case. The long arms are long in design so that they can cooperate with earthing tabs 36 of a stationary contact unit, shown in FIG. 7, provided for this spring contact unit. The short arms are short in design so that they have as small a face as possible for couplings and keep the space requirement low. While the stationary contacts 14 in the first embodiment are formed by welded-on contact pieces, stationary contacts 34 in the second embodiment, as shown in FIG. 7, are produced by the material of the contact elements. Contact pieces could also be welded on, in this case. The design of the stationary contacts depends on the required switching properties.

FIG. 8 shows how the stationary contact unit in FIG. 7 is encapsulated by injection moulding with plastics material and the spring contact unit is positioned with the armature 5. It should also be noted how the fastening elements 28 are connected to assembly arms 35, which results in the establishment of an armature swivel axis.

A plurality of further embodiment possibilities are conceivable which contains the essential ideas of the invention, namely keeping the face of the contact elements as small as possible and providing an intermediary piece which forms a spring element and is earthed. The present embodiments allow simple and economical production as both the spring contact unit and the stationary contact unit can, in each case, be produced from a single metal sheet. Only simple stamping and bending processes and plastics material injection moulding processes are necessary for this purpose.

I/we claim:

1. A spring contact unit for a relay with a rocker armature comprising
at least two spring contacts designed as bridge contacts,
a spring element arranged between the spring contacts, and
two fastening elements arranged in the middle on two opposing sides of the spring element
wherein the spring contacts are fastened in an insulated manner to an outer end of the spring element and resilient portions are located between the fastening points of the spring contacts on the spring element and a central region of the spring element.

2. The spring contact unit according to claim 1, wherein the longitudinal axes of the spring contacts extend substantially perpendicularly to the longitudinal axis of the spring element.

3. The spring contact unit according to claim 1, wherein a connecting element made of plastics material, in each case, forms the insulating fastening of the spring contacts on the spring element.

4. The spring contact unit according to claim 1, wherein the longitudinal axes of the spring contacts extend substantially parallel to the longitudinal axis of the spring element.

5. The spring contact unit according to claim 1, wherein the spring contacts are designed as slotted leaf springs so that double contacts are formed.

6. The spring contact unit according to claim 5, wherein the legs of the spring contacts formed by the slotting are different in length, wherein the slots separate a long leg from a short leg, in each case.

7. The spring contact unit according to claim 1, wherein the spring element is substantially designed in the form of an 8.

8. The spring contact unit according to claim 1, wherein the end regions of the spring contacts bear switching contacts.

9. The spring contact unit according to claim 4, wherein the spring element is designed in a U-shape on the two sides of the central region and the spring contacts are located between the legs of the U, wherein the legs of the U extend over the total length of the spring contacts and are therefore suitable for screening.

10. The relay with a spring contact unit according to claim 1 with a rocker armature actuated by a magnetic system, the rocker armature being connected to the spring element of the spring contact unit in such a way that an armature swivel axis is established by the fastening elements.

11. The relay according to claim 10, wherein the spring contacts are connected in the opened state, in each case, with earthing tabs.

12. Relay according to claim 10, wherein the armature is connected to the spring element via a molded-plastic component.
